(19) United States
(12) Patent Application Publication
(10) Pub. No.: US 2008/0243922 A1
(43) Pub. Date: Oct. 2, 2008

(54) System and method for marketing real estate

(76) Inventor: Eric Herm, Boynton Beach, FL (US)

Correspondence Address: LOUIS VENTRE, JR, 2483 OAKTON HILLS DRIVE, OAKTON, VA, 22124-1530, US

(21) Appl. No.: 11/694,502

(22) Filed: Mar. 30, 2007

(51) Int. Cl. G06F 17/30

(52) U.S. Cl. 707/104.1

(57) ABSTRACT

A system and method for marketing real estate in which an advertising broker (10) enters an agreement with a listing broker requiring the advertising broker to place advertisements relating the conveyance of a real estate property interest wherein the advertisements are placed in exchange for a percentage of the sale price of the real estate (15). The advertising broker saves information in a database detailing a description of the real estate incident to the real estate for sale (20). The advertising broker accesses that information (25) and converts the information to marketing information that summarizes the description of the real estate (30). The advertising broker places advertisements relating to the real estate for sale in multiple advertising media (35). The advertising broker provides further information on the real estate for sale to any interested buyer (40) and transmits any offer to the listing broker (45).

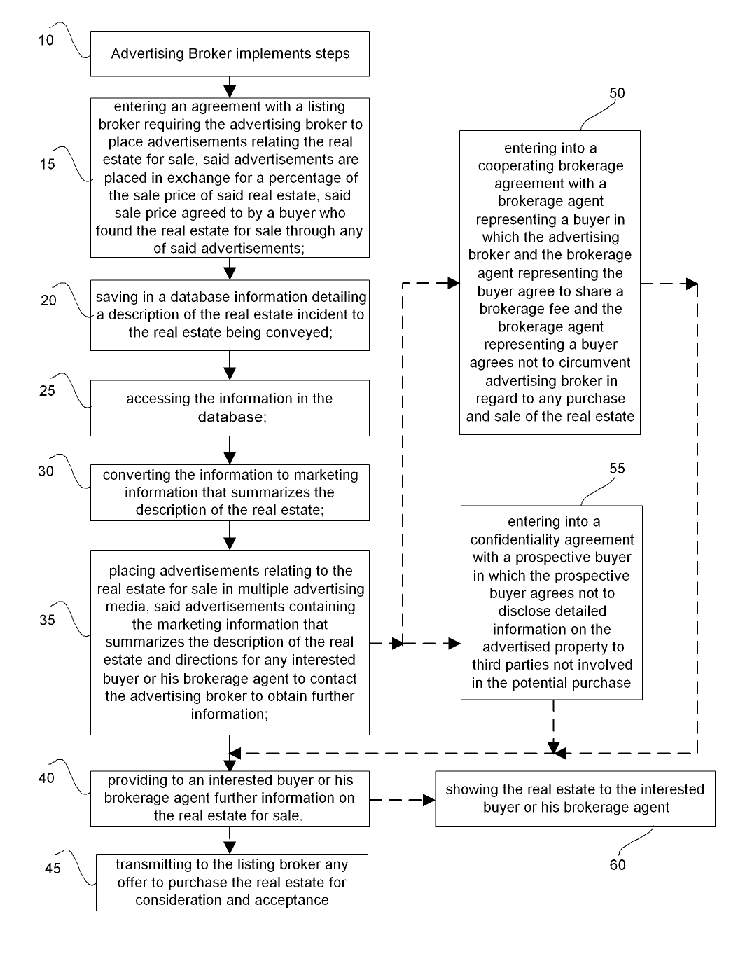

### FIELD OF INVENTION

In the field of real estate, a system and method improves advertising related to the conveyance of an interest in real estate.

### BACKGROUND

The preferred embodiment disclosed herein builds upon and is an improvement to the existing system and method of advertising, that is marketing, real estate. The improved marketing system and method disclosed herein may be practiced for the marketing of any type of real estate, such as for example, commercial, industrial, cemeterial, government-owned, non-government-owned, undeveloped land, and newly constructed and existing residential properties.

This system and method may be practiced in regard to all types of conveyances of real property interests for such real estate, such as sales, auctions, trades, and leases. To simplify this disclosure and avoid unnecessary repetition, reference herein to the sale of real estate, or to real estate for sale, is intended to mean and include every type of conveyance of real property interest. Reference to a purchase of real estate is intended to refer to the acquisition of any type of ownership interest in real property. Reference to the sale price includes the price paid, the rental amount to be paid, or the value of any other form of compensation received in exchange for an interest in real estate. Reference to the seller means and includes the person conveying an interest in real estate such as a seller, trader, exchanger, or lessor. And finally, reference to the buyer means and includes the person who is acquiring an interest in real estate such as a buyer, exchanger, or lessee.

In the existing system and method for marketing real estate, a real estate listing broker, that is a real estate agent who is typically licensed by the state in which the property is located, is engaged by a seller to convey a real estate interest. The seller is typically the owner or other person having authority to transfer ownership of a real estate interest. A principal is defined herein to include an owner of the real estate to be conveyed and a purchaser of that interest, that is namely, a seller, buyer, trader, exchanger, lessor or lessee.

The listing broker thereupon lists the real estate for sale and handles the administrative details of showing the real estate and consummating the sale. The listing broker's compensation is usually a realty or brokerage fee, generally in a range of about 3 to 8 percent of the agreed upon sales price of the real estate. A listing for sale typically involves adding the property description to the Multiple Listing Service (MLS), employing a sign on the real estate directing purchasers to contact the listing broker, placement of an advertisement in a newspaper and describing the property on a web site owned or sponsored by the realty company employing the listing agent.

A buyer or buyer's broker oftentimes sees one of these listings of the real estate for sale, contacts his broker or the listing broker, visits or inspects the property in person and negotiates for its purchase. The buyer's broker often shares the brokerage fee previously agreed upon between the listing broker and the seller. The agreed upon share for the buyer's broker is an amount usually up to half of the brokerage fee.

### DESCRIPTION OF PRIOR ART

Methods for assisting in the buying and selling of property have been disclosed in prior art, but none has the features or the efficiencies offered by the present invention. For example, U.S. Pat. No. 7,016,866 provides a single point of contact for principals, negotiators and third party service providers in the real estate market, offering a forum for identifying needs, presenting solutions and accessing a suite of real estate tools and services. The present invention is different in that its purpose is not to create a single point of contact for principals, negotiators, and third party service providers in the real estate market, but rather is aimed at broadening advertising of real estate through the efforts of an advertising broker.

Subscriber based real estate information is known in the prior art to assist in advertising real estate, the foremost example being the Multiple Listing Service (MLS). A related prior art example is U.S. Pat. No. 6,883,002 that discloses a subscriber-based real estate information exchange process and system that includes a computer connected to the Internet. Real estate agents subscribe to the Multiple Listing Service (MLS). Such subscribing agents may then provide access to the Multiple Listing Service (MLS) to their clients, typically after such clients register as a prospective principal that is buying, selling, exchanging, trading, or leasing properties.

The present invention is far broader than a subscriber-based system and is not limited to Multiple Listing Service (MLS) properties, but includes any real property interest conveyance. Additionally, the preferred embodiment of the present invention uniquely introduces a quality means of marketing through a state-licensed advertising broker in an innovative series of steps not disclosed in the prior art. The advertising broker, in compliance with state and federal laws, adds value by assisting buyers and buyer brokers with expert knowledge about a property and its conveyance that would not be available if a listing broker hired an advertising company or an auctioneer to market. Additionally, a traditional marketing company is no substitute for an advertising broker of the present invention because many advertising media require that an advertiser actually hold a real estate license. Without such license, the media for advertising are restricted.

Advertising over the Internet is also well known. For example, U.S. Pat. No. 6,968,513 is for an online interactive web site information system for increasing access to localized business and markets, the system having one of more functions for displaying advertising. The advertising, information and/or business listings enable geographic targeting of users and allows merchants in the geographic areas to direct the advertising, information and/or business listings to localized geographic locations. Here again the present invention is far broader in advertising in media other than the Internet and is further distinguished in that it involves a specific set of steps involving brokerage agents and others not disclosed in the '513 patent.

Any method, like the current invention, that improves the real estate advertising holds the potential to benefit all parties involved in the sale and purchase of real estate, but most especially the principals and also the listing and buying brokers.

The preferred embodiment of the invention helps solve a “listing broker's” problem that they do not have enough time to market a property in order to get it sold. In addition, it can be at no additional cost to the listing broker and typically would be considered as free advertising for every listing the listing broker may have. The listing broker may actually reduce costs and improve profit because advertising costs would be assumed by the advertising agent from the agreed upon compensation.

The preferred embodiment of the invention helps implement a real estate seller's goal in having their property advertised to as many people as possible in as many media as possible. In addition, this system and method is implemented at no additional cost to the seller.

The preferred embodiment of the invention helps the buyer's broker by enabling him to easily find property meeting a buyer's requirements. Implementation of the expert marketing strategy of the advertising broker broadly expands the potential for such brokers to become knowledgeable about, and aware of, a real estate offer, which serves their needs.

The preferred embodiment of the invention helps buyers by providing more choices for real estate meeting their requirements. When an advertising broker cumulates the listings of multiple listing brokers, a broadened buyer community will be made aware of more properties that are for sale. For instance, the preferred embodiment will reach buyers who use the Internet and those who do not use the Internet. It is unique in that there is a problem with market trends, motivations, and needs and wants to meet the demands of buyers and sellers.

Accordingly, the present invention will serve to improve the prior art by solving problems of inadequacies of advertising experienced by all parties involved in the sale and purchase of real estate. The efficiency gains offered by the method of the invention implemented by an advertising broker most especially serve the interests of listing broker, seller, buyer's broker, and buyer involved in the sale and purchase of real estate. These benefits are established when a sales contract is consummated and then executed. At that point, all broker, buyers, and principals are typically fully aware of their reward in closing the transaction, having taken part in a system and method that maximizes the opportunity for a market driven purchase price from a maximum field of potential purchasers.

### BRIEF SUMMARY OF THE INVENTION

A system and method for marketing real estate in which a listing broker enters an agreement with an advertising broker requiring the advertising broker to place advertisements relating the real estate conveyances. The advertising broker is compensated by a percentage of the sale price of the real estate. The advertising broker saves information in a database detailing a description of the real estate incident to the real estate conveyance. The advertising broker accesses that information and converts the information to marketing information that summarizes the description of the real estate. The advertising broker places advertisements relating to the real estate being conveyed in multiple advertising media. The advertising broker provides further information on the real estate being conveyed to any interested buyer and transmits any offer to the listing broker.

### BRIEF DESCRIPTION OF THE DRAWING

The FIGURE is a block diagram of the steps in the preferred embodiments of the invention.

### DETAILED DESCRIPTION

In the following description, reference is made to the accompanying drawing, which forms a part hereof and which illustrates several embodiments of the present invention. The drawings and the preferred embodiments of the invention are presented with the understanding that the present invention is susceptible of embodiments in many different forms and, therefore, other embodiments may be utilized, including those with a different order of steps in the method and those with operational changes without departing from the scope of the present invention.

The invention is a method improving the current system and method for marketing real estate. The invention uses an advertising broker, that is a broker or real estate agent dedicated to maximizing a real estate advertising campaign, to broadly disseminate the availability of the property to many potential purchasers. To comply with regulatory requirements, the advertising broker is typically one or more licensed real estate agents authorized to perform realty functions in the states where real estate to be marketed is located.

Referring to the drawing to illustrate with a block diagram the method of the preferred embodiment, the advertising broker implements the steps (10) of the invention.

A first step (15) is typically the entering an agreement between the listing broker and the advertising broker that requires the advertising broker to place advertisements relating the real estate for sale. The advertisements are placed in exchange for a percentage of the sale price of the real estate, the sale price being that agreed to by a buyer who found the real estate for sale through any of said advertisements. The real estate for sale may be a single property or a plurality of properties for which the listing broker has responsibility to convey. Typically, for a corporate listing broker employing a plurality of real estate agents, the listing broker would have full authority to decide what agents they want to be enrolled with the advertising agent and also what properties managed by these agents would be included in the agreement.

The percentage of the sale price is typically up to half of the brokerage fee agreed to by the seller and the listing broker. Ideally, the listing broker incurs no additional cost beyond that which he would otherwise incur in sharing the brokerage fee with a buyer's broker. The agreement therefore promotes the interests of the seller and the listing broker by promoting the advertisement and sale of the real estate without additional cost to either the seller or the listing broker. A preferred embodiment is best illustrated by an example involving three brokers, a listing broker, an advertising broker, and a buyer's broker. In this example, the commission established in the agreement between the listing broker and the principal would preferably be divided into thirds. The exact amount of commission sharing is preferably specified in the agreement between the advertising broker and listing broker, who are free to negotiate the fee structure for sharing among brokers. Preferably, both the advertising broker and the listing broker agree that neither will disclose to any other person without the consent of the other the agreed upon fee structure for sharing among brokers.

A second step (20) is typically saving in a database information detailing a description of the real estate incident to the real estate for sale. This information may come from the listing broker or from the research of the advertising broker. This information is usually the detailed information about the property and its ownership that could be provided to a interested purchaser upon making initial inquiry to the listing broker and may include confidential information about the principal or property that would only be provided to a serious purchaser after their bona fides is established or a deposit is offered on the property. Preferably, a corporate listing broker by this point in a transaction would typically have agreed to allow the advertising broker access to any of their employee agents' listings and associated specific marketing materials, such as surveys, photos, brochures, financial numbers, and other information.

Examples of this varied and diverse information include property type, unit type, selling price, taxing district, assessed value, tax rate, owner's name and contact information, mortgage information, availability time slots for showing, owner closing, scheduling and access restrictions, school district, address information, actual built-up area, age, renovation description, sewer district, furnishing description, corner unit indicator, number of bedrooms and floor location, number of bathrooms and floor location, amenities, number of stories, free form description of property, total land area, shape of land area, dimensions of rooms, income from property rental or use, high/low rise, apartment/condo facilities description, and scenic views.

This data is typically significantly more information that would be published in any advertisement on the property and is information that might be considered confidential. It thus must be handled and stored by the advertising broker in a manner commensurate with its characteristics. Storing the information in a database is necessary both as a source of derivative publishable advertising information and for later use by the advertising broker in promoting a sale of the real estate.

A third step (25) is typically accessing the information in the database. The advertising broker must access the information in the database if an advertising campaign is to reflect the actual real estate to be advertised and sold. Such access is typically, but not required to be, by a computer to enable fast and accurate handling of the information.

A fourth step (30) is typically converting the accessed information to marketing information that summarizes the description of the real estate. Conversion may also include, but is not limited to, using base data like tax rates to determine actual and expected property taxes, projecting electricity and other utility costs, and projecting income potential from commercial property. Converting the accessed information to marketing information also eliminates confidential information that should not be published in advertising media. The database may reside in computer readable memory. When the database resides in computer readable memory, a computer would implement a program that performs the steps of accessing the information in the database and converting the information to marketing information that summarizes the description of the real estate. In this embodiment, the advertising broker employs a computer to automate and perform the conversion of the accessed information in the database to marketing information.

A fifth step (35) is typically placing advertisements relating to the real estate for sale in multiple advertising media. Such advertising media would typically exclude advertising normally performed by the listing broker, such as the Multiple Listing Service (MLS) and conveyance signage on the subject property, such as “for sale” or “for rent.” Multiple Listing Service (MLS) listings also present information that is different in kind and detail from the marketing information placed in advertisements for property. The advertising broker would place advertisements that summarize the description of the real estate and directions for any interested buyer or buyer's broker to contact the advertising broker to obtain further information. Thus, such advertisements would typically be placed in advertising media not used by the listing broker, such as subscription-based free access Internet sites, fee-based access websites, Internet search engine web and sponsored sites, television, radio, Internet chat sites, facsimile publications, email, and online and in-print newspapers, magazines, bulletins, mailers, billboards, and any others that would add to the exposure of the property to potential buyers.

A sixth step (40) is typically providing to an interested buyer or his brokerage agent further information on the real estate for sale. In this sense, the advertising broker acts much like the listing broker and takes over many of the administrative tasks in describing the property and cultivating an offer of purchase from the interested buyer. This relieves the listing broker of some of the administrative tasks that the listing broker might otherwise have performed. For a similar purpose, an optional step (60) is employed wherein the advertising broker shows the real estate to the interested buyer or his brokerage agent. Here again, the usual function of the listing broker is performed by the advertising broker.

A seventh step (45) is typically transmitting to the listing broker any offer to purchase the real estate for consideration and acceptance. The advertising broker involves the listing broker to interact with the buyer and complete the sale, much as would occur if the advertising broker were the listing broker.

An optional step (50) is applicable when a buyer's broker contacts the advertising broker. Typically, these two brokers would enter into a cooperating brokerage agreement. Preferably, before both parties enter any cooperating brokerage agreement, the advertising broker would determine the commission rate for that particular property by either accessing that information in the database or, if necessary, contacting the listing broker. If the listing broker has employed an administrative assistant, then the advertising broker would typically first contact the administrative assistant in order to lessen the administrative burdens on the licensed listing broker. This optional step clarifies the relationship and potential income of the advertising broker and the buyer's broker. The agreement would typically contain provisions specifying that these two brokers would share in the brokerage fee that the advertising broker negotiated with the listing broker, and pledging that the brokerage agent representing a buyer will not circumvent the advertising broker in regard to any purchase and sale of the real estate.

An optional step (55) is applicable when a prospective buyer, who is not represented by a buyer's broker, contacts the advertising broker. Typically, the prospective buyer and the advertising broker would enter into a confidentiality agreement with a prospective buyer in which the prospective buyer agrees not to disclose detailed information on the advertised property to third parties not involved in the potential purchase.

The disclosure herein is to be considered as an exemplification of the principles of the invention and is not intended to limit the broad aspect of the invention to the embodiments illustrated. Thus, the scope of the invention is determined by the appended claims and their legal equivalents rather than by the examples given.

What is claimed is:

1. A system and method for marketing real estate wherein a real estate listing broker lists real estate for sale typically in the Multiple Listing Service (MLS) and with a sign on the real estate and a buyer or buyer's broker finds the real estate for sale and negotiates for its purchase wherein the improvement comprises using a licensed advertising broker implementing the steps of:
(a) entering an agreement with a listing broker requiring the advertising broker to place advertisements relating the real estate for sale, said advertisements are placed in exchange for a percentage of the sale price of said real estate, said sale price agreed to by a buyer who found the real estate for sale through any of said advertisements;
(b) saving in a database information detailing a description of the real estate incident to the real estate being conveyed;
(c) accessing the information in the database;
(d) converting the information to marketing information that summarizes the description of the real estate;
(e) placing advertisements relating to the real estate for sale in multiple advertising media, said advertisements containing the marketing information that summarizes the description of the real estate and directions for any interested buyer or his brokerage agent to contact the advertising broker to obtain further information; and,
(f) providing to an interested buyer or his brokerage agent further information on the real estate for sale.

2. The system and method of claim 1 wherein the real estate for sale includes a plurality of properties.

3. The system and method of claim 1 wherein said advertisements are placed in advertising media selected from a group consisting of subscription-based free access Internet sites, fee-based access websites, Internet search engine web and sponsored sites, television, radio, Internet chat sites, facsimile publications, email, and online and in-print newspapers, magazines, bulletins, and mailers, and billboards.

4. The system and method of claim 1 wherein the database resides in computer readable memory and a computer implements a program that performs the steps of accessing the information in the database and converting the information to marketing information that summarizes the description of the real estate.

5. The system and method of claim 1 further comprising the step of entering into a confidentiality agreement with a prospective buyer in which the prospective buyer agrees not to disclose detailed information on the advertised property to third parties not involved in the potential purchase.

6. The system and method of claim 1 further comprising the step of entering into a cooperating brokerage agreement with a brokerage agent representing a buyer in which the advertising broker and the brokerage agent representing the buyer agree to share a brokerage fee and the brokerage agent representing a buyer agrees not to circumvent advertising broker in regard to any purchase and sale of the real estate.

7. The system and method of claim 1 further comprising the step of showing the real estate to the interested buyer or his brokerage agent.

8. The system and method of claim 1 further comprising the step of transmitting to the listing broker any offer to purchase the real estate for consideration and acceptance.
